(19) United States
(12) Patent Application Publication
(10) Pub. No.: US 2026/0073664 A1
(43) Pub. Date: Mar. 12, 2026

(54) Systems and Methods for Countertop Recognition for Home Valuation

(71) Applicant: STATE FARM MUTUAL AUTOMOBILE INSURANCE COMPANY, Bloomington, IL (US)

(72) Inventors: Geetha Priya Nagarajan, Plano, TX (US); Hariprakash Taniga Ejilane, Allen, TX (US); Reuven Birnbaum, Urbana, IL (US); Anjela Spreen, Hewitt, TX (US)

(21) Appl. No.: 19/384,071

(22) Filed: Nov. 10, 2025

Related U.S. Application Data
(63) Continuation of application No. 18/096,954, filed on Jan. 13, 2023.
(60) Provisional application No. 63/421,929, filed on Nov. 2, 2022.

(51) Int. Cl. G06V 10/764; G06Q 40/08; G06Q 50/163; G06T 7/60; G06V 10/22; G06V 20/70

(52) U.S. Cl. CPC G06V 10/764; G06Q 40/08; G06Q 50/163; G06T 7/60; G06V 10/22; G06V 20/70; G06T 2207/20081

(57) ABSTRACT

The following relates generally to (i) identifying a type of countertop in a home, and/or (ii) using a type of countertop to estimate a value of a home and/or determine a homeowners insurance premium. In some embodiments, one or more processors receive a first plurality of images including depictions of countertops, and train a countertop identification machine learning algorithm based upon the first plurality of images. The one or more processors may then receive a second plurality of images, which (i) includes a greater number of images than the first plurality of images, and (ii) includes labeled objects. The one or more processors may then further train the countertop identification machine learning algorithm based upon the second plurality of images.

### CROSS REFERENCE TO RELATED APPLICATIONS

This application is a continuation of U.S. patent application Ser. No. 18/096,954, entitled “Systems and Methods for Countertop Recognition for Home Valuation” (filed Jan. 13, 2023), which claims the benefit of U.S. Provisional Application No. 63/421,929, entitled “Systems and Methods for Countertop Recognition for Home Valuation” (filed Nov. 2, 2022), the entirety of which is incorporated by reference herein.

### FIELD

The present disclosure generally relates to, inter alia: (i) identifying a type of countertop in a home, and/or (ii) using a type of countertop to estimate a value of a home and/or determine a homeowners insurance premium.

### BACKGROUND

Artificial intelligence (AI) and machine learning are rapidly expanding technological areas. However, techniques for using machine learning to identify countertops in images may be sorely lacking.

The systems and methods disclosed herein provide solutions to this problem and others, and may provide solutions to the ineffectiveness, insecurities, difficulties, inefficiencies, encumbrances, and/or other drawbacks of conventional techniques.

### SUMMARY

The present embodiments relate to, inter alia, identifying a type of countertop in a home. For example, some embodiments train a machine learning algorithm to identify specific types of countertops in a home, and then use the trained machine learning algorithm to identify a type of countertop in a photo that an insurance customer (or other user) uploads. Once the countertop type is identified, some embodiments leverage the knowledge of the type of countertop to produce an estimate for a value of the insurance customer's home, and/or determine a homeowners insurance premium for the insurance customer.

In one aspect, a computer-implemented method for determining a countertop type may be provided. The method may be implemented via one or more local or remote processors, sensors, transceivers, servers, memory units, augmented reality glasses or headsets, extended or virtual reality headsets, smart glasses or watches, wearables, and/or other electronic or electrical components. In one instance, the method may include: (1) training a countertop identification machine learning algorithm by, during a first training phase: (a) receiving, via one or more processors, a first plurality of images; (b) identifying, via the one or more processors, bounding boxes in images of the first plurality of images, wherein the bounding boxes surround countertop depictions in the images; (c) identifying, via the one or more processors, labels for countertop types for the countertop depictions surrounded by the bounding boxes, wherein the countertop type labels include: granite, laminate, quartz, wood, ceramic tile, non-laminate, marble, stainless steel, concrete, and/or unknown; and/or (d) training, via the one or more processors, the countertop identification machine learning algorithm based upon the labels for the countertop types; (2) further training the countertop identification machine learning algorithm by, during a second training phase: (a) receiving, via the one or more processors, a second plurality of images, wherein the second plurality of images: (i) includes a greater number of images than the first plurality of images, and/or (ii) includes labeled objects; and/or (b) further training the countertop identification machine learning algorithm based upon the labeled objects; (3) receiving, via the one or more processors, an image from a user; and/or (4) routing, via the one or more processors, the image from the user into the trained countertop identification machine learning algorithm to identify a type of a countertop in the image. The method may include additional, fewer, or alternate actions, including those discussed elsewhere herein.

In another aspect, a computer system configured for determining a countertop type may be provided. The computer system may include one or more local or remote processors, sensors, transceivers, servers, memory units, augmented reality glasses or headsets, extended or virtual reality headsets, smart glasses or watches, wearables, and/or other electronic or electrical components. In one instance, the computer system may include one or more processors configured to: (1) train a countertop identification machine learning algorithm by, during a first training phase: (a) receiving a first plurality of images; (b) identifying bounding boxes in images of the first plurality of images, wherein the bounding boxes surround countertop depictions in the images; (c) identifying labels for countertop types for the countertop depictions surrounded by the bounding boxes, wherein the countertop type labels include: granite, laminate, quartz, wood, ceramic tile, non-laminate, marble, stainless steel, concrete, and/or unknown; and/or (d) training the countertop identification machine learning algorithm based upon the labels for the countertop types; (2) during a second training phase, further train the countertop identification machine learning algorithm by: (a) receiving a second plurality of images, wherein the second plurality of images: (i) includes a greater number of images than the first plurality of images, and/or (ii) includes labeled objects; and/or (b) further training the countertop identification machine learning algorithm based upon the labeled objects; (3) receive an image; and/or (4) route the image into the trained countertop identification machine learning algorithm to identify a type of a countertop in the image. The computer system may include additional, less, or alternate functionality, including that discussed elsewhere herein.

In yet another aspect, a computer device for determining a countertop type may be provided. The computer device may include (or be configured to work with or wirelessly communication with) one or more local or remote processors, sensors, transceivers, servers, memory units, augmented reality glasses or headsets, extended or virtual reality headsets, smart glasses or watches, wearables, and/or other electronic or electrical components. In one instance, the computer device may include: one or more processors; and/or one or more memories coupled to the one or more processors. The one or more memories including computer executable instructions stored therein that, when executed by the one or more processors, may cause the one or more processors to: (1) train a countertop identification machine learning algorithm by, during a first training phase: (a) receiving a first plurality of images; (b) identifying bounding boxes in images of the first plurality of images, wherein the bounding boxes surround countertop depictions in the images; (c) identifying labels for countertop types for the countertop depictions surrounded by the bounding boxes, wherein the countertop type labels include: granite, laminate, quartz, wood, ceramic tile, non-laminate, marble, stainless steel, concrete, and/or unknown; and/or (d) training the countertop identification machine learning algorithm based upon the labels for the countertop types; (2) during a second training phase, further train the countertop identification machine learning algorithm by: (a) receiving a second plurality of images, wherein the second plurality of images: (i) includes a greater number of images than the first plurality of images, and/or (ii) includes labeled objects; and/or (b) further training the countertop identification machine learning algorithm based upon the labeled objects; (3) receive an image; and/or (4) route the image into the trained countertop identification machine learning algorithm to identify a type of a countertop in the image. The computer device may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an exemplary computer system for (i) identifying a type of countertop in an image, (ii) estimating a home value based upon a countertop type, and/or (iii) providing a homeowner's insurance quote based upon a countertop type, according to one embodiment.

FIG. 2 illustrates an exemplary image of an exemplary kitchen.

FIG. 3 illustrates an exemplary image of an exemplary bathroom.

FIG. 4 illustrates an exemplary block diagram of an exemplary machine learning modeling method for training and evaluating a countertop identification machine algorithm, in accordance with various embodiments.

FIG. 5A illustrates an exemplary block diagram of an exemplary machine learning modeling method for training and evaluating a home valuation machine learning algorithm and/or insurance determining machine learning algorithm, in accordance with various embodiments.

FIG. 5B illustrates an exemplary table of historical information that may be used to train a home valuation machine learning algorithm and/or insurance determining machine learning algorithm, in accordance with various embodiments.

FIG. 6 depicts an exemplary computer-implemented method or implementation for determining a countertop type.

### DETAILED DESCRIPTION

Broadly speaking, the following provides an efficient system for, inter alia, any or all of: (i) identifying a type of countertop in an image, (ii) estimating a home value based upon a countertop type, and/or (iii) providing a homeowners insurance quote based upon a countertop type.

In some embodiments, the system may train a machine learning algorithm, such as a countertop identification machine learning algorithm, to identify specific countertop types in images. For example, the machine learning algorithm may be trained to identify granite, laminate, quartz, wood, ceramic tile, non-laminate, marble, stainless steel, and/or concrete countertop types.

In some examples, the system may train the countertop machine learning algorithm via techniques that are advantageous specifically with respect to identification of countertops. In one such example, the system may receive a plurality of images of rooms of a home (e.g., a first plurality of images). The system may then further first identify images of kitchens and/or bathrooms (e.g., the rooms where the countertops are more likely to be), and then train the machine learning algorithm based upon the images of the kitchens and bathrooms, thus avoiding training on images that are not likely to include countertops. In another such example, which is particularly useful in scenarios where only a limited number of images including countertops are available, the system may first train the countertop identification machine learning algorithm based upon images that include countertops, and subsequently train the countertop identification machine learning algorithm based upon images that do not include countertops but that do include other objects (e.g., cabinets). Advantageously, this helps train the countertop identification machine learning algorithm to distinguish between the countertops, and the other objects (e.g., helps train the machine learning algorithm to distinguish between cabinets and countertops).

Furthermore, in some embodiments, the system may use a type of countertop as part of estimating a value of a home (e.g., via a home valuation machine learning algorithm). Additionally or alternatively, the system may also determine a homeowners insurance premium (e.g., by inputting the countertop type, and/or estimated value of the home into an insurance determining machine learning algorithm).

### Exemplary Computer System

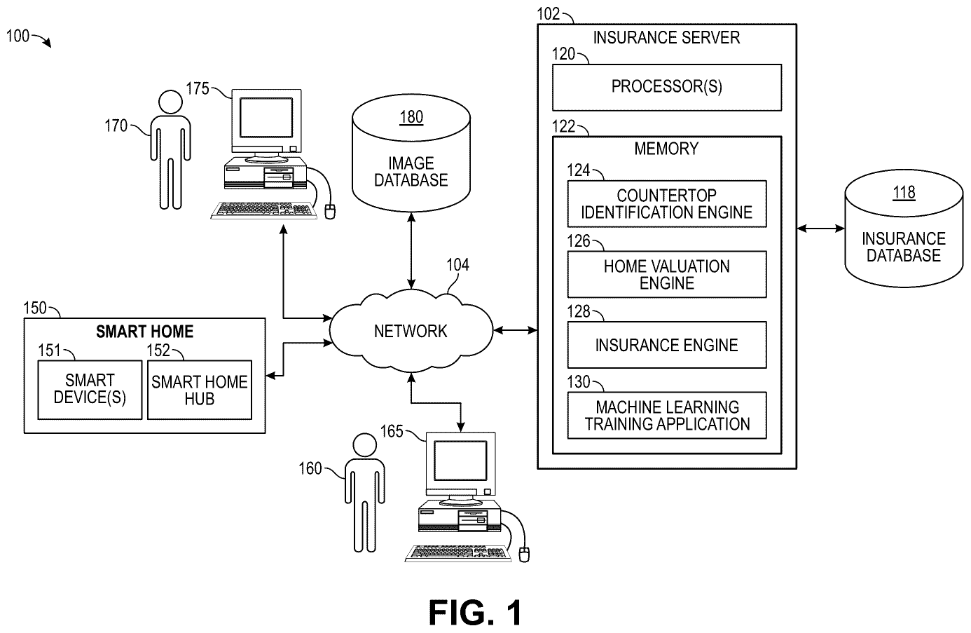

FIG. 1 shows an exemplary computer system 100 for (i) identifying a type of countertop in an image, (ii) estimating a home value based upon a countertop type, and/or (iii) providing a homeowners insurance quote based upon a countertop type in which the exemplary computer-implemented methods described herein may be implemented. The high-level architecture includes both hardware and software applications, as well as various data communications channels for communicating data between the various hardware and software components. Although the example system 100 illustrates only one of many of the components, any number of the example components are contemplated (e.g., any number of users, user devices, smart homes, insurance servers, image databases, insurance databases, etc.). The illustrated example components may be configured to communicate, e.g., via a network 104 (which may be a wired or wireless network, such as the internet), with any other component.

By way of brief overview, the insurance server 102 may perform the functions that any or all of (i) identify a type of countertop in an image, (ii) estimate a home value based upon a countertop type, and/or (iii) provide a homeowners insurance quote.

The insurance server 102 may include one or more processors 120 such as one or more microprocessors, controllers, and/or any other suitable type of processor. The insurance server 102 may further include a memory 122 (e.g., volatile memory, non-volatile memory) accessible by the one or more processors 120, (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the insurance server 102 to provide access to the computer-readable instructions stored thereon. In particular, the computer-readable instructions stored on the memory 122 may include instructions for executing various applications, such as countertop identification engine 124, home valuation engine 126, insurance engine 128, and/or machine learning training application 130.

In operation, the countertop identification engine 124 may identify a type of countertop in an image. The countertop identification engine 124 may identify the type of countertop via any suitable technique. For example, the countertop identification engine 124 may apply a countertop identification machine learning algorithm to identify the type of countertop. In this regard, as part of identifying the type of countertop, the countertop identification machine learning algorithm may first identify a location of a countertop in the image. To this end, to identify the location, the machine learning algorithm may place a bounding box around a location where it has determined that the depiction of the countertop in the image is.

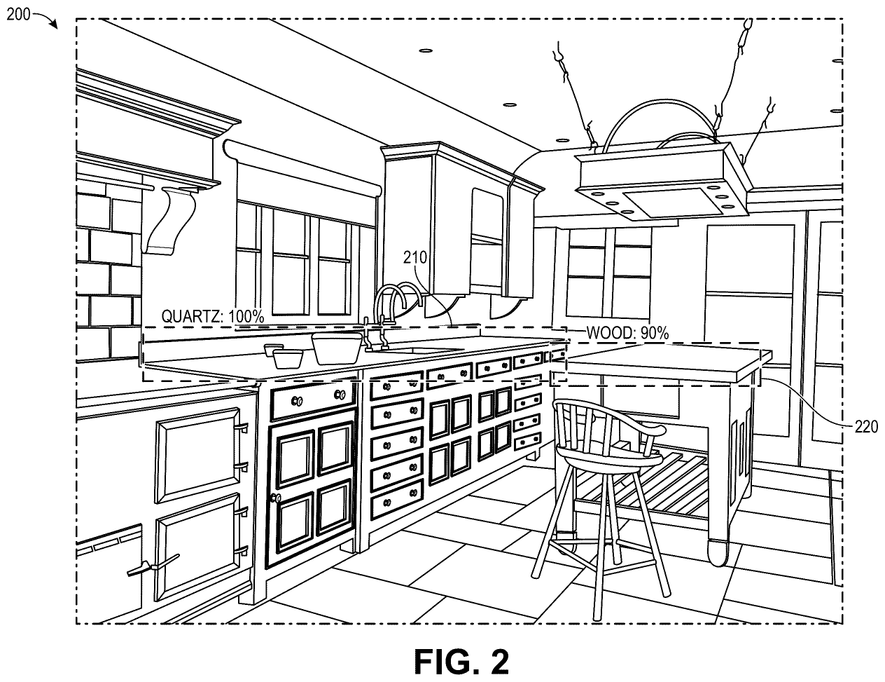

In this regard, FIG. 2 illustrates an exemplary image 200 of an example kitchen. The illustrated example includes a bounding box 210 placed around a first countertop, and a bounding box 220 placed around a second countertop. The countertop identification machine learning algorithm may also assign a countertop type label and/or a confidence of the countertop type to the bounding boxes. For instance, in the illustrated example, the countertop identification machine learning algorithm has determined that the countertop of bounding box 210 has a type of quartz with 100% confidence, and has also determined that the countertop of bounding box 220 has a countertop type of wood with 90% confidence.

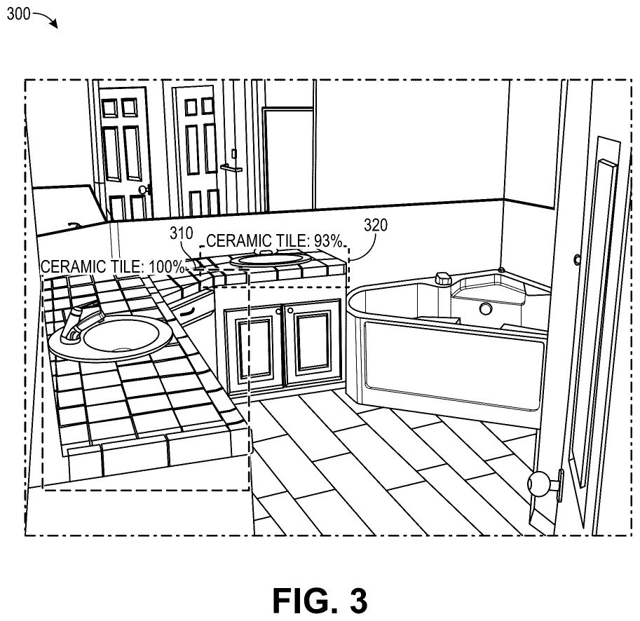

Further in this regard, FIG. 3 illustrates an exemplary image 300 of an example bathroom. The illustrated example includes a bounding box 310 placed around a first countertop, and a bounding box 320 placed around a second countertop. The countertop identification machine learning algorithm may assign a countertop type label and/or a confidence of the countertop type to the bounding boxes. For instance, in the illustrated example, the countertop identification machine learning algorithm has determined that the countertop of bounding box 310 has a type of ceramic tile with 100% confidence, and has also determined that the countertop of bounding box 320 has a countertop type of ceramic tile with 93% confidence.

In operation, the home valuation engine 126 may estimate the value of a home. The home valuation engine 126 may determine the value of the home via any suitable technique. For example, the home valuation engine 126 may determine the value of the home via a home valuation machine learning algorithm. In some embodiments, the home valuation machine learning algorithm estimates the home value based at least in part upon a countertop type (e.g., as identified by the countertop identification engine 124).

In operation, the insurance engine 128 may determine a homeowners insurance premium (e.g., to be included in a homeowners insurance quote presented to the user 160). The insurance engine 128 may determine the homeowners insurance premium by any suitable technique. For example, the insurance engine 128 may determine the homeowners insurance premium via an insurance determining machine learning algorithm. In some embodiments, the insurance determining machine learning algorithm determines the homeowners insurance premium based at least in part upon a countertop type (e.g., as identified by the countertop identification engine 124). Additionally or alternatively, the insurance determining machine learning algorithm may determine the homeowners insurance premium based at least in part upon the estimated value of the home estimated by the home valuation engine 126.

Any of the machine learning algorithms discussed herein, such as the countertop identification machine learning algorithm, the home valuation machine learning algorithm, and/or the insurance determining machine learning algorithm, may be trained by the machine learning training application 130. The data that the machine learning algorithms are trained on may come from any suitable source. For example, the data may be sent by the image database 180 (e.g., any database that stores images, etc.), which may store images. It should be understood that images, as referred to herein, refers to still images, as well as images comprised in videos. In some examples, images from a video (e.g., all or some of images from a scene of a video, etc.) may be aggregated together (e.g., to be input to the machine learning algorithm to train the machine learning algorithm or to make a prediction). The data used to train the machine learning algorithms may come from any other source as well, such as the insurance database 118, the trainer device 175, the smart home 150, the user device 165, etc.

Moreover, in some embodiments, a trainer 170 may assist the machine learning training application 130 in training the machine learning algorithm. In one working example, the trainer 170 is a human that is presented with an image on the trainer device 175. The trainer 170 then uses the trainer device 175 to draw a bounding box around a countertop and/or identify a countertop type in the image, and the trainer device 175 then sends this information to the insurance server 102. The machine learning training application 130 then uses the received information as part of a supervised learning process to train the countertop identification machine learning algorithm. The trainer device 175 may be any suitable device, such as a computer, a tablet, a phablet, a smartphone, a camera, etc.

Furthermore, any of the identified countertop type, the estimated home value, and/or the determined insurance premium may be stored in the insurance database 118. The insurance database 118 may, additionally or alternatively, store any other kind of data, such as information of insurance customers (e.g., the user 160). The information of insurance customers may include information of insurance claims, information of the homes of the insurance customers, payment history of the insurance customers, etc.

In some examples, the home that the countertop type is identified in may be a home of the user 160. In this regard, in some examples, the user 160 uses the user device 165 to send an image of a room to the insurance server for identification of a countertop type, estimation of a home value, and/or determination of a homeowners insurance premium. The user device 165 that uploads the image may be any suitable device, such as a computer, a tablet, a phablet, a smartphone, a camera, etc.

Additionally or alternatively, the home that the countertop type is identified in may be the smart home 150. In some such examples, one or more smart devices 151 obtains an image of a room in the smart home 150, and sends the image (possibly via the smart home hub 152) to the insurance server 102 for identification of a countertop type, estimation of a home value, and/or determination of a homeowners insurance premium. Examples of the one or more smart devices 151 include devices with cameras, devices that communicate with cameras, etc.

### Exemplary Countertop Identification Machine Learning Algorithm

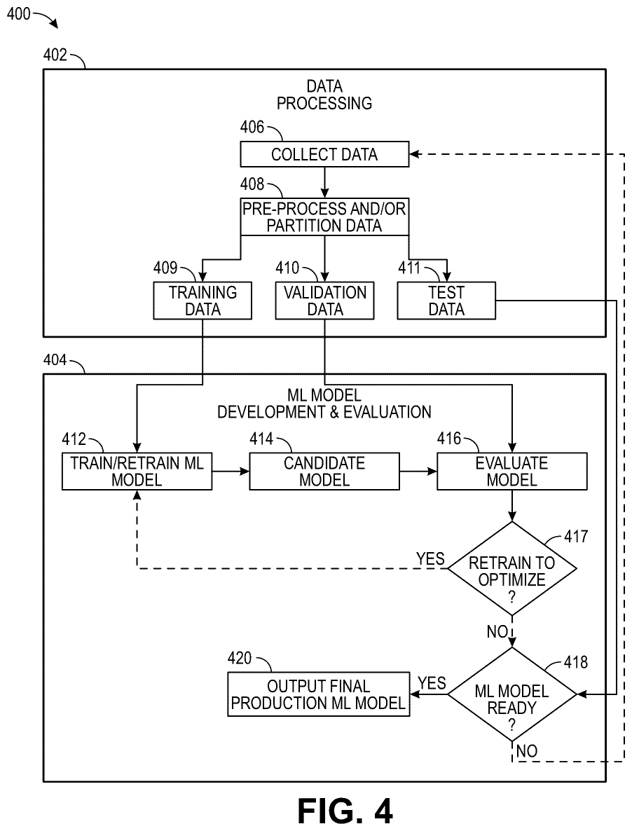

Broadly speaking, one or both of the machine learning training application 130 and/or the countertop identification engine 124 may train a machine learning algorithm to, for example, identify a countertop type in an image. FIG. 4 is a block diagram of an exemplary machine learning modeling method 400 for training and evaluating a machine learning model (e.g., a machine learning algorithm), in accordance with various embodiments. In some embodiments, the model “learns” an algorithm capable of performing the desired function, such as identifying a countertop type. However, it should be understood that the principles of FIG. 4 may apply to any machine learning algorithm discussed herein.

At a high level, the machine learning modeling method 400 includes a block 402 for preparation of model input data, and a block 404 for model training and evaluation. The model training, storage, and implementation may be performed at either of the machine learning training application 130 and/or the countertop identification engine 124, or at any other suitable component.

Depending on implementation, one or more machine learning models may be implemented to train multiple classifiers at the same time. The different trained classifiers may be further operated separately or in conjunction to detect different countertop types. Accordingly, the training data may be associated with any number of tags (e.g., labels) associated with different countertop types such that a classifier can be trained to detect attributes indicative of the tag. In this sense, the tag may be an indication that the underlying training data includes attributes indicative of the tag, and the absence of a tag may be an indication that the underlying training data does not include the attributes indicative of the tag. Training multiple classifiers may provide an advantage of expediting calculations and further increasing specificity of prediction for each classifier's particular instance space.

Depending on implementation, the machine learning model may be trained based upon the tags using supervised learning, unsupervised learning, or semi-supervised learning. Such learning paradigms may include reinforcement learning. Supervised learning is a learning process for learning the underlying function or algorithm that maps an input to an output based upon example input-output combinations. A “teaching process” compares predictions by the model to known answers (labeled data) and makes corrections in the model. The trained algorithm is then able to make predictions of outputs for unlabeled input data. In such embodiments, the data (e.g., historical image data) may be labeled according to the corresponding output (e.g., a countertop type, etc.). In some supervised learning examples, the trainer 170 places the labels on historical images (e.g., via the trainer device 175).

Unsupervised learning is a learning process for generalizing the underlying structure or distribution in unlabeled data. In embodiments utilizing unsupervised learning, the system may rely on unlabeled historical image data. During unsupervised learning, natural structures are identified and exploited for relating instances to each other. Semi-supervised learning can use a mixture of supervised and unsupervised techniques. This learning process discovers and learns the structure in the input variables, where typically some of the input data is labeled, and most is unlabeled. The training operations discussed herein may rely on any one or more of supervised, unsupervised, or semi-supervised learning, depending on the embodiment.

Block 402 may include any one or more blocks or sub-blocks 406-411, which may be implemented multiple times in any suitable order. At block 406, one or both of the machine learning training application 130 and/or the countertop identification engine 124 may obtain training data from the image database 180, the insurance database 118, the trainer device 175, the smart home 150, and/or the user device 165.

At block 408, relevant data (for pre-processing and/or partitioning) may be selected from among available data (e.g., historical data, which may be anonymized). Training data may be assessed and cleaned, including handling missing data and handling outliers. For example, missing records, zero values (e.g., values that were not recorded), incomplete data sets (e.g., for scenarios when data collection was not completed), outliers, and inconclusive data may be removed. In some embodiments, to combat overfitting, some training images may be augmented, such as by cropping, rotating, color scaling, etc., one or more of the training images. Additionally or alternatively, in some embodiments, training images are resized (e.g., to a certain size, such as 512×512 pixels). In order to select high predictive value features, special feature engineering techniques may be used to derive useful features from the datasets. For example, data may be visualized for the underlying relationships to determine which feature engineering steps should be assessed for performance improvement. This step may include manually entering user input (e.g., from the trainer device 175, from a user interface of the insurance server 102, etc.) to define possible predictive variables for the machine learning model. Manual user input may also include manually including or excluding variables selection after running special feature engineering techniques. Manual user input may be guided by an interest to evaluate, for example, an interaction of two or more predictor variables (e.g., color and/or size of the countertop to predict the countertop type, etc.).

Furthermore, at block 408, various measures may be taken to ensure a robust set of training data (e.g., providing standardized, heterogeneous data, removing outliers, imputing missing values, and so on).

In addition, at block 408, the collected data may then be partitioned into training data 409, validation data 410, and/or test data 411. The partitioning may be done manually, or by any suitable automated technique. Some or all of the training data 409, validation data 410, and/or test data 411 sets may be labeled with pre-determined answers (e.g., input from trainer device 175, etc.). It should be appreciated that even if the training data 409, validation data 410, and/or test data 411 came from the same source, the training data 409, validation data 410, and/or test data 411 may be kept separate from each other to avoid biasing the model evaluation.

In some examples, the training data 409, validation data 410, and/or test data 411 may include user input (e.g., from trainer devices 175, user devices 165, and/or smart homes 150), such as to provide positive or negative reinforcement training of the countertop identification machine learning algorithm.

Block 404 illustrates an exemplary countertop identification machine learning (ML) model development and evaluation phase. Block 404 may include any one or more blocks or sub-blocks 412-420, which may be implemented in any suitable order. In one example, at block 412, the training module trains the countertop identification machine learning model by running the training data 409, thereby generating candidate model 414.

Regarding block 412, developing the model may involve training the model using training data 409. At a high level, the countertop identification machine learning model may be utilized to discover relationships between various observable features (e.g., between predictor features and target features) in a training dataset, which can then be applied to an input dataset to predict unknown values for one or more of these features given the known values for the remaining features. At block 404, these relationships are discovered by feeding the model pre-processed training data 409 including instances each having one or more predictor feature values and one or more target feature values. The model then “learns” an algorithm capable of calculating or predicting the target feature values (e.g., to identify a countertop type) given the predictor feature values.

In certain embodiments, special feature engineering techniques may be used to extract or derive the best representations of the predictor variables to increase the effectiveness of the model. To avoid overfitting, in some embodiments feature reduction may be performed. In some embodiments, feature engineering techniques may include an analysis to remove uncorrelated features or variables. Variables may be evaluated in isolation to eliminate low predictive value variables, for example, by applying a cut-off value.

Further regarding block 412, the countertop identification machine learning model may be trained (e.g., by one or both of the machine learning training application 130 and/or the countertop identification engine 124) to thereby generate the classifiers. Techniques for training/generating the classifiers that apply tags to the input data may include gradient boosting, neural networks, deep learning, linear regression, polynomial regression, logistic regression, support vector machines, decision trees, random forests, nearest neighbors, or any other suitable machine learning technique. Example object detection models include Faster R-CNN, Gated R-CNN, Pyramid Networks, Single-Shot Detector (SSD), and You Only look Once (YOLO multiple versions). In some examples, one or both of the machine learning training application 130 and/or the countertop identification engine 124 implements gradient boosting machine learning (for example, using the open source extreme gradient boosting (XGBoost) algorithm) with a secondary application of the model for close cases and/or error correction. In certain embodiments, training the countertop identification machine learning model may include training more than one classifier according to the selected method(s) on the training data 409 pre-processed at block 408 implementing different method(s) and/or using different sub-sets of the training data, or according to other criteria.

Additionally, the countertop identification machine learning model may include multiple layers. For example, in a first layer, the countertop identification machine learning model may be configured to segment image data of the training data to identify and/or label objects. For example, the first layer may identify that the image data includes a countertop, a cabinet, a dog, a cat, a toilet, a sink, a shower, a bathtub, etc. Accordingly, in addition to applying a tag that indicates the detected object type, the classifiers in the first layer may identify a segment of the image data of the training data that includes the image data representative of the object. In this example, the second layer may then be configured to analyze the segmented image data to identify the particular conditions of the object associated with a countertop (e.g., a type of the countertop, etc.). Accordingly, the countertop identification machine learning model may include different classifiers in the second layer that are applied in response to different tags applied by the first layer.

In another example, the first layer identify what type of room that the image is of (e.g., kitchen, bathroom, bedroom, living room, dining room, sun room, porch, home gym, home office, etc.). In some implementations, the images that are not of kitchens and/or bathrooms (e.g., the rooms likely to include countertops) are discarded (e.g., the countertop identification machine learning algorithm is not trained on them). Advantageously, this accomplishes the training of the countertop identification machine learning algorithm much more quickly because a countertop is much more likely to be in the images that the algorithm is trained on.

The candidate model 414 may then be evaluated at block 416. The evaluation may involve testing the model using the validation data 410. The validation data 410 may include both predictor feature values and target feature values (e.g., including order demand patterns for which corresponding delivery patterns are known), enabling comparison of target feature values predicted by the model to the actual target feature values, enabling one to evaluate the performance of the model. This evaluation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical image data), and use this assessment as a proxy for predictive accuracy on future data. Exemplary accuracy metrics include key performance indicators, comparisons between historical trends and predictions of results, cross-validation with subject matter experts, comparisons between predicted results and actual results, etc. In some embodiments, detection metrics, such as intersection over union (IOU) and/or mean average precision (mAP), may be used for insight regarding how well the model is locating an object (e.g., how well the model is drawing a bounding box, etc.), and classifying an object.

At block 417, it is determined if the evaluated model should be retrained to optimize the model. The determination may be made based on any suitable criteria, such as how the model performed during the evaluation at block 416. If the determination is to retrain the model, the example method 400 returns to block 412.

The retraining of the model at block 412 may include re-running the model to improve the accuracy of prediction values (e.g., using validation data, cross-validation data, etc.). For example, re-running the model may improve model training when implementing gradient boosting machine learning. In another implementation, re-running the model may be necessary to assess the differences caused by an evaluation procedure. For instance, available data sets from the image database 180, insurance database 118, the trainer device 175, the smart home 150, the user device 165 may be split into training and testing data sets by randomly assigning sub-sets of data to be used to train the model or evaluate the model to meet the predefined train or test set size, or an evaluation procedure may use a k-fold cross validation. Both of these evaluation procedures are stochastic, and, as such, each evaluation of a deterministic machine learning model, even when running the same algorithm, provides a different estimate of error or accuracy. The performance of these different model runs may be compared using one or more accuracy metrics, for example, as a distribution with mean expected error or accuracy and a standard deviation. In certain implementations, the models may be evaluated using metrics such as root mean square error (RMSE), to measure the accuracy of prediction values.

If, at block 417, the determination is not to retrain the model, a determination is made as to if the ML model is ready for deployment (block 418). In some embodiments, the determination is made based upon the test data 411. Regarding block 418, one or both of the machine learning training application 130 and/or the countertop identification engine 124 may utilize any suitable set of metrics to determine whether or not the countertop identification machine learning algorithm has been sufficiently trained on the current dataset. Generally speaking, the decision at block 418 will depend on one or more accuracy metrics generated during the evaluation from block 416. Additionally or alternatively, in some examples, the determination may be manually made by a human.

In one working example, the countertop machine learning algorithm has been trained on an initial set of images that include countertops. However, the initial set of images may not be sufficient to robustly train the countertop machine learning algorithm (e.g., the number of available images including countertops is small). Thus, it may be desirable to continue to train the countertop machine learning algorithm with an additional (possibly larger) set of images even if the additional set of images does not include countertops (or only includes a small number of countertops). For example, if the additional set of images includes cabinets, this may help the countertop machine learning algorithm learn to distinguish between a countertop and a cabinet.

If the determination is made that the ML model is not ready, the method may return to block 406 to collect further training data to restart the process. It may be further noted that if a “no” determination is made at block 418 it is possible to return to block 412; however, such implantations often introduce data leakage. Thus, it is advantageous to return to block 406 following a “no” determination at block 418.

If the determination is made at block 418 that the ML model is ready, the final model may be output at block 420.

### Exemplary Home Valuation and Insurance Determining Machine Learning Algorithms

Broadly speaking, the machine learning training application 130, the home valuation engine 126, and/or the insurance engine 128 may train: (i) a home valuation machine learning algorithm to, for example, estimate a home value, and/or (ii) an insurance determining machine learning algorithm to, for example, determine an insurance premium.

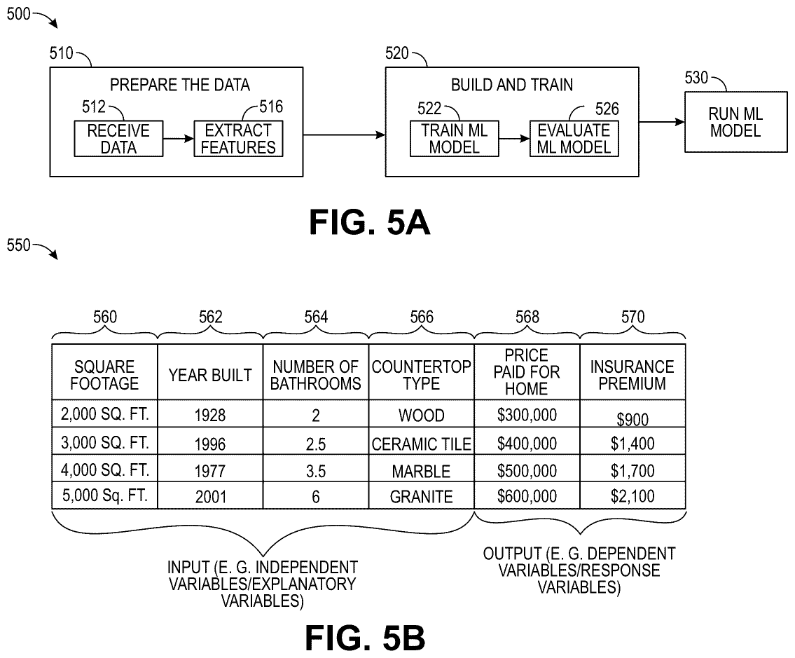

FIG. 5A is a block diagram of an exemplary machine learning modeling method 500 for training and evaluating a machine learning model (e.g., a machine learning algorithm), in accordance with various embodiments. In some embodiments, the model “learns” an algorithm capable of performing the desired function, such as estimating a home value (for the home valuation machine learning algorithm), and determining an insurance premium (for the insurance determining machine learning algorithm). It should be understood that the principles of FIG. 5A may apply to any machine learning algorithm discussed herein. Furthermore, although the following discussion refers to the machine learning training application 130 as performing the illustrated blocks, it should be understood that the home valuation engine 126, and/or the insurance engine 128 may additionally or alternatively perform any of the illustrated blocks.

At a high level, the machine learning modeling method 500 includes a block 510 to prepare the data, a block 520 to build and train the model, and a block 530 to run the model.

Block 510 may include sub-blocks 512 and 516. At block 512, the machine learning training application 130 may receive the historical information to train the machine learning algorithm. The historical information may include any information of historical homes, historical sales of the historical homes, historical insurance premiums of the historical homes, etc. Examples of the historical information include: (i) square footages of historical homes, (ii) years built of the historical homes, (iii) number of bathrooms of the historical homes, (iv) countertop types of historical homes, (v) prices paid for the historical homes, and/or (vi) insurance premiums of the historical homes.

In some embodiments, the machine learning algorithm may be trained using the above (i)-(iv) as inputs to the machine learning model (e.g., also referred to as independent variables, or explanatory variables), and the above (v)-(vi) are used as the outputs of the machine learning model (e.g., also referred to as a dependent variables, or response variables). Put another way, each of the above (i)-(iv) may have an impact on (v)-(vi), which the machine learning algorithm is trained to find.

In some scenarios, a single machine learning algorithm is trained to estimate a price for a home, and to determine an insurance premium. In other scenarios a single machine learning algorithm (e.g., a home valuation machine learning algorithm) is trained to estimate the home value, and/or a single machine learning algorithm is trained to determine the insurance premium (e.g., an insurance determining machine learning algorithm). In still other scenarios, a first machine learning algorithm (e.g., a home valuation machine learning algorithm) is trained to estimate the home value, and a second machine learning algorithm (e.g., an insurance determining machine learning algorithm) is trained to take the output of the first machine as an input (e.g., additionally or alternatively to the above (i)-(iv)) to determine the insurance premium.

In some embodiments, the historical information may be held in the form of a table, such as the example table 550 illustrated in the example of FIG. 5B. The illustrated example table 550 includes square footage 560, year built 562, number of bathrooms 564, countertop type 566, price paid for home 568, and insurance premium 570. It should be appreciated that the data table 550 is one example data structure associated with the historical information. In other examples, the insurance server 102 may implement one or more alternate data structures that represent the historical information.

In some embodiments, training the machine learning algorithm based upon less information (e.g., three or less of the inputs (i)-(iv)) has a technical advantage. Namely, the home value and/or insurance premium may be calculated faster because there is less data to consider.

In other embodiments, training the machine learning algorithm based upon more information (e.g., all four of the inputs (i)-(iv)) has a technical advantage. Namely such embodiments may have the advantage that the estimated home value and/or determined insurance premium may be more accurate because more data points are used.

Generally, the machine learning model is trained to identify how each of the input variables may influence the output variables. For example, the machine learning models may determine that a larger square footage results in a higher home value and/or insurance premium.

It should be appreciated that while the foregoing sets out some input factors to the machine learning model, in other embodiments, additional, alternate, or fewer factors are used. In some embodiments, an input to the machine learning model trained at block 520 may be the output of another machine learning model trained to produce a metric characterizing the home. For example, the output of the home valuation machine learning algorithm may be used as the input to the insurance premium determining machine learning algorithm.

At block 516 the machine learning training application 130 may extract features from the received data, and put them into vector form. For example, the features may correspond to the values associated with the historical data used as input factors. Furthermore, at block 516, the received data may be assessed and cleaned, including handling missing data and handling outliers. For example, missing records, zero values (e.g., values that were not recorded), incomplete data sets (e.g., for scenarios when data collection was not completed), outliers, and inconclusive data may be removed.

Block 520 may include sub-blocks 522 and 526. At block 522, the machine learning (ML) model is trained (e.g. based upon the data received from block 510). In some embodiments, the ML model “learns” an algorithm capable of calculating or predicting the target feature values (e.g., estimating a home value and/or determining an insurance premium) given the predictor feature values.

At block 526, the machine learning training application 130 evaluates the machine learning model, and determines whether or not the machine learning model is ready for deployment.

Further regarding block 526, evaluating the model sometimes involves testing the model using testing data or validating the model using validation data. Testing/validation data typically includes both predictor feature values and target feature values (e.g., including known inputs and outputs), enabling comparison of target feature values predicted by the model to the actual target feature values, enabling one to evaluate the performance of the model. This testing/validation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical information, such as the historical information of FIG. 5B), and use this assessment as a proxy for predictive accuracy on future data. Exemplary accuracy metrics include key performance indicators, comparisons between historical trends and predictions of results, cross-validation with subject matter experts, comparisons between predicted results and actual results, etc.

At block 530, the machine learning training application 130 runs the ML model. For example, information associated with a home may be routed to the trained machine learning algorithm to estimate a home value, and/or determine the insurance premium.

### Exemplary Computer-Implemented Methods

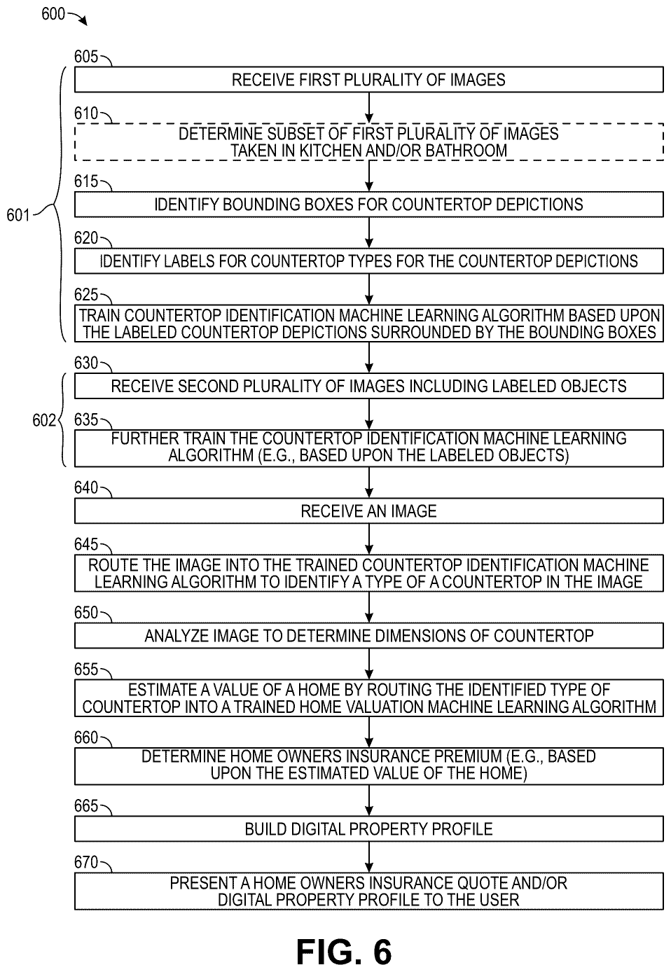

FIG. 6 shows an exemplary computer-implemented method or implementation 600 for determining a countertop type. With reference thereto, and broadly speaking, in some embodiments, a countertop identification machine learning algorithm may be trained to identify countertop types in images. However, regarding the training data, it may be that there is only a small number of images including countertops available, while a large number of images including objects besides countertops are available. To compensate for the small number of images including countertops, the countertop identification machine learning algorithm may be trained, in part, on images that do not include countertops, but do include other objects. For example, training the countertop identification machine learning algorithm on images that do not include countertops, but do include cabinets, may help the countertop identification machine learning algorithm to distinguish between countertops and cabinets. Advantageously, this additional training on images that do not include countertops improves the accuracy of the machine learning algorithm.

In this regard, the exemplary method 600 may include two training phases. Specifically, a first training phase 601 may train the countertop identification machine learning algorithm on a first plurality of images where all or many of the images in the first plurality of images include depictions of countertops. And, a second training phase 602, may further train the countertop identification machine learning algorithm on a second plurality of images where the second plurality of images includes images without depictions of countertops, or includes a lower percentage of images with countertops than the first plurality of images (e.g., the percentage of images with countertops in the second plurality of images is lower than the percentage of images with countertops in the first plurality of images). Moreover, because images without countertops may be easier to obtain, in some embodiments, the number of images in the second plurality of images is greater than the number of images in the first plurality of images.

Furthermore, in view of the following discussion, it should be appreciated that the training may be any of a supervised learning process, a semi-supervised process, or an unsupervised learning process.

The exemplary method 600 may begin at block 605 when the one or more processors 120 receive a first plurality of images. The first plurality of images may be received from any suitable source. For example, the first plurality of images may be received from: the image database 180, the insurance database 118, trainer devices 175, user devices 165, and/or smart homes 150.

Furthermore, the first plurality of images may be received individually, as a group of images, and/or in groups of images. For example, the first plurality of images may include image(s) from the: user device 165, trainer device 175, smart home 150, images database 180, and/or insurance database 118.

The received first plurality of images may include information that a human has entered. In one such example, the trainer 170 uses the training device 175 to: place a bounding box around a depiction of a countertop, label the depiction of the countertop with a type of countertop, and/or indicate a type of room that the image is of. Examples of the types of countertops include: granite, laminate, quartz, wood, ceramic tile, non-laminate, marble, stainless steel, concrete, and/or unknown.

However, in some embodiments, images of the first plurality of images received by the one or more processors 120 do have any or all of the above information applied to them. For example, the first plurality of images may include unlabeled images from the image database 180.

At optional block 610, the one or more processors 120 may determine a subset of the first plurality of images that are of a kitchen and/or bathroom. This block is advantageous to perform in embodiments where it is desired to increase the proportion of images in the first plurality of images including countertops used for training during the first training phase. For example, if it is desired to accomplish the entire training during the first training phase 601 (e.g., embodiments where there is no second training phase 602), then it may be advantageous to include block 610. In one such example, there may be enough images including countertops to train the countertop identification machine learning algorithm without using images that do not include countertops. In this example, it may be faster to train the machine learning algorithm on only the images including countertops than to train the machine learning algorithm on both images that include countertops, and do not include countertops.

The subset of the first plurality of images may be determined by any suitable technique. For example, the images of the first plurality of images may be received along with information indicating what type of room that the image is of (e.g., the trainer 170 uses the training device 175 to label an image before sending to the insurance server 102). In another example, the one or more processors 120 determine this via geolocation data automatically added to the image. For instance, a camera capturing an image may automatically add geolocation data to the image, and the one or more processors 120 determine the room type based upon the geolocation data and a known layout of the house (e.g., an insurance customer has house blueprints stored in the insurance database 118, etc.). In yet another example, the one or more processors 120 use a room identification machine learning algorithm to determine the room type.

At block 615, the one or more processors 120 identify bounding boxes surrounding countertop depictions in the first plurality of images. Illustrative examples of bounding boxes include bounding boxes 210, 220 of FIG. 2, and bounding boxes 310, 320 of FIG. 3.

The bounding boxes may be identified based upon any suitable technique. For example, a trainer 170 may have, via the trainer device 175, indicated bounding boxes in images that she sent to the one or more processors 120 (e.g., at block 605). In this example, the one or more processors 120 may identify the bounding boxes based upon this input for the trainer 170. In other examples, the one or more processors 120 may automatically place the bounding boxes (e.g., via an image recognition technique, e.g., in a semi-supervised learning process).

At block 620, the one or more processors 120 identify labels for countertop types for the countertop depictions surrounded by the bounding boxes. The labels for the countertop types may be identified based upon any suitable technique. For example, a trainer 170 may have, via the trainer device 175, indicated labels for types of countertops in images that she sent to the one or more processors 120 (e.g., at block 605). In this example, the one or more processors 120 may identify the labels for the countertop types based upon this input for the trainer 170. In other examples, the one or more processors 120 may automatically identify the labels (e.g., via an image recognition technique, e.g., in a semi-supervised learning process).

At block 625, the one or more processors 120 train the countertop identification machine learning algorithm based upon the labels for the countertop types.

At block 630, the exemplary method 600 enters the second training phase 602, and the one or more processors 120 receive a second plurality of images. As mentioned above, in some scenarios, a group of images (e.g., the first plurality of images) including a high proportion of images with countertop depictions (e.g., 90% or more of the images of the first plurality of images include countertops) may not have enough images to sufficiently train the machine learning algorithm to identify countertops. Thus, it may be advantageous to continue to train the countertop identification machine learning algorithm on an additional group of images (e.g., the second plurality of images). In one working example, if the countertop identification machine learning algorithm is trained only on the first group of images, the countertop identification machine learning algorithm may have difficulty distinguishing between certain types of countertops and cabinets. Thus, in this example, it becomes advantageous to further train the countertop identification machine learning algorithm based upon a second dataset including a high proportion of cabinets, even if the second data set includes a low proportion of depictions of countertops (e.g., 10% or less of the images of the second data set include countertops).

Furthermore, in some scenarios, because of the scarcity of images including countertops, the first plurality of images includes less total images than the second plurality of images (e.g., the first plurality of images includes 1,000 images, whereas the second plurality of images includes 2,000 images).

The second plurality of images may be received from any suitable source. For example, the second plurality of images may be received from: the image database 180, the insurance database 118, trainer devices 175, user devices 165, and/or smart homes 150. In one working example, the first plurality of images is received from trainer devices 175 and/or user devices 165 (e.g., from people who have volunteered to send images including countertops), whereas the second plurality of images is received from the image database 118 (e.g., a general database of images, etc.).

Furthermore, the second plurality of images may be received individually, as a group of images, and/or in groups of images. For example, the second plurality of images may include image(s) from the: user device 165, trainer device 175, smart home 150, images database 180, and/or insurance database 118.

In addition, the received second plurality of images may include information that a human has entered. In one such example, the trainer 170 uses the training device 175 to: place a bounding box around a depiction of a countertop, label the depiction of the countertop with a type of countertop, and/or indicate a type of room that the image is of. In another example, the second plurality of images include bounding boxes around objects other than countertops, and include labels of the objects. For example, the second plurality of images may include bounding boxes around cabinets, and labels indicating that the objects are cabinets, thus advantageously improving the training of the countertop machine learning algorithm by improving the countertop machine learning algorithm's ability to distinguish between cabinets and certain types of countertops.

However, in some embodiments, images of the second plurality of images received by the one or more processors 120 do have any or all of the above information applied to them. For example, the second plurality of images may include unlabeled images from the image database 180. In addition, it should be understood that, in some embodiments, some of the objects in the second plurality of images are cabinets, and are labeled as such.

At block 635, the one or more processors 120 further train the countertop identification machine learning algorithm. For example, the countertop identification machine learning algorithm may be further trained based upon the labeled objects from the second plurality of images.

Furthermore, it should be appreciated that not both training phases 601, 602 are required to be performed. For example, the machine learning algorithm may be completely trained to draw bounding boxes around countertops and/or identify countertop types at phase 601. In another example, the machine learning algorithm may be completely trained to draw bounding boxes around countertops and/or identify countertop types at phase 602.

It should still further be appreciated that two machine learning algorithms may be trained, and then chained together. For example, a bounding box machine learning algorithm may be trained (e.g., at one or both of phases 601, 602) to draw a bounding box around a counter top; and, a countertop identification machine learning algorithm may be trained (e.g., at one or both of phases 601, 602) to identify countertops. In some such examples, to identify a countertop, an image may first be input into the bounding box machine learning algorithm, which draws a bounding box around a countertop; the one or more processors 120 may optionally then crop an image within the bounding box (e.g., an image specifically of the countertop), and the cropped image may then be input into the countertop identification machine learning algorithm to identify the type of countertop.

At block 640, the one or more processors 120 receive an image. The image may be received from any suitable source, such as the image database 180, the insurance database 118, trainer devices 175, user devices 165, and/or smart homes 150. In one example, the user 160 may be contemplating purchasing a homeowners insurance policy (e.g., from an insurance company of the insurance server 102). In accordance with the principles discussed herein, the user 160 may upload images of her home (e.g., at block 640), and, in response, receive a homeowners insurance quote, a presentation of a digital property profile, etc.

At block 645, the one or more processors 120 route the image into the trained countertop identification machine learning algorithm to determine the type of a countertop depicted in the image. It should be appreciated that the countertop identification machine learning algorithm may identify more than one countertop in the image, and/or identify more than one type of countertop in the image.

At block 650, the one or more processors 120 analyze image to determine dimensions of the countertop, such as a width, length, and/or thickness of the countertop, in the image. In some examples, the dimensions are determined by the countertop identification machine learning algorithm. Additionally or alternatively, the dimensions may be determined by a separate algorithm (e.g., an algorithm that determines generally dimensions of any objects). Additionally or alternatively, in some embodiments, the one or more processors 120 may identify if the countertop has a backslash and/or is over- or under-mounted to a sink.

Furthermore, in some embodiments, block 650 is performed before block 645. In some such examples, the determined dimensions of the countertop are routed into the countertop identification machine learning algorithm to help the countertop identification machine learning algorithm determine the type of the countertop (e.g., the countertop identification machine learning algorithm takes the countertop dimensions as an independent variables or explanatory variables). This may be advantageous because, during training, the countertop identification machine learning algorithm may correlate countertop dimensions with certain types of countertops.

At block 655, the one or more processors 120 estimate the value of the home by routing the identified type of countertop into a trained home valuation machine learning algorithm (e.g., trained as disused above with respect to FIGS. 5A-5B, etc.). Additionally or alternatively, the dimensions of the countertop determined at block 650 may be routed into the trained home valuation machine learning algorithm. Said another way, the trained home valuation machine learning algorithm may estimate the value of the home based at least in part upon: (i) the type of countertop, and/or (ii) the dimensions of the countertop.

In some embodiments, it may be that the countertop identification machine learning algorithm has determined more than one type of countertop. In some such embodiments, any or all of the determined countertop types may be routed into the home valuation machine learning algorithm. Alternatively, in some embodiments, the one or more processors 120 route only one of the determined countertop types into the home valuation machine learning algorithm. For example, the one or more processors 120 may use a ranked list of the countertop types to determine which countertop type is routed into the home valuation machine learning algorithm. Additionally or alternatively, the one or more processors 120 may route a countertop type with a highest degree of confidence into the home valuation machine learning algorithm. For instance, in the example of FIG. 2, a countertop type of quartz may be routed into the home valuation machine learning algorithm because the quartz countertop type has a higher degree of confidence than the wood countertop type.

At block 660, the one or more processors 120 determine a homeowners insurance premium. The homeowners insurance premium may be determined by any suitable technique. For example, the homeowners insurance premium may be determined by routing the estimated home value and/or the determined countertop type into a trained insurance determining machine learning algorithm (e.g., trained as discussed above with respect to FIGS. 5A-5B, etc.). Additionally or alternatively, the homeowners insurance premium may be determined based upon lookup table(s) (e.g., a lookup table that correlates estimated home values with insurance premiums).

At block 665, the one or more processors 120 build a digital property profile of the home corresponding to the image received at block 640. The digital property profile may include any information of the home. For example, the digital property profile may include images of the home, such as the image received at block 640. In some embodiments, an image included in the digital property profile includes the countertop with the countertop dimensions overlaid onto it.

The digital property profile may also include a homeowners insurance quote (e.g., including the determined homeowners insurance premium). The digital property profile may still further include any other information of the home. For example, the insurance database 118 may have information of the home that may be included in the digital property profile, such as year built, square footage, number of bedrooms, number of bathrooms, building materials used, school districts that the home corresponds to, additional images of the home, etc.

At block 670, the one or more processors 120 present an insurance quote (e.g., including the insurance premium), and/or digital property profile to the user 160 (e.g., via the user device 165).

It should be understood that not all blocks and/or events of the exemplary flowcharts are required to be performed. Moreover, the exemplary flowcharts are not mutually exclusive (e.g., block(s)/events from each flowchart may be performed in any other flowchart). The exemplary flowcharts may include additional, less, or alternate functionality, including that discussed elsewhere herein.

### Additional Exemplary Embodiments

In one aspect, a computer-implemented method for determining a countertop type may be provided. The method may be implemented via one or more local or remote processors, sensors, transceivers, servers, memory units, augmented reality glasses or headsets, extended or virtual reality headsets, smart glasses or watches, wearables, and/or other electronic or electrical components. In one instance, the method may include: (1) training a countertop identification machine learning algorithm by, during a first training phase: (a) receiving, via one or more processors, a first plurality of images; (b) identifying, via the one or more processors, bounding boxes in images of the first plurality of images, wherein the bounding boxes surround countertop depictions in the images; (c) identifying, via the one or more processors, labels for countertop types for the countertop depictions surrounded by the bounding boxes, wherein the countertop type labels include: granite, laminate, quartz, wood, ceramic tile, non-laminate, marble, stainless steel, concrete, and/or unknown; and/or (d) training, via the one or more processors, the countertop identification machine learning algorithm based upon the labels for the countertop types; (2) further training the countertop identification machine learning algorithm by, during a second training phase: (a) receiving, via the one or more processors, a second plurality of images, wherein the second plurality of images: (i) includes a greater number of images than the first plurality of images, and/or (ii) includes labeled objects; and/or (b) further training the countertop identification machine learning algorithm based upon the labeled objects; (3) receiving, via the one or more processors, an image from a user; and/or (4) routing, via the one or more processors, the image from the user into the trained countertop identification machine learning algorithm to identify a type of a countertop in the image from the user. The method may include additional, fewer, or alternate actions, including those discussed elsewhere herein.

In some embodiments, the first training phase is a supervised learning phase, and/or the identifying the bounding boxes includes identifying, via the one or more processors, the bounding boxes according to bounding box input received from trainer devices.

In some embodiments, the identifying the labels includes identifying, via the one or more processors, the labels according to input received from trainer devices.

In some embodiments, during the first training phase: the method further includes, prior to the identifying of the bounding boxes, determining, via the one or more processors, a subset of the first plurality of images that are of a bathroom and/or kitchen; and/or the applying the bounding boxes comprises applying the bounding boxes only to the subset of the first plurality of images.

In some embodiments, the method further includes estimating a value of a home by routing the identified type of countertop into a trained home valuation machine learning algorithm.

In some embodiments, the method further includes: determining, via the one or more processors, a homeowners insurance premium based upon the estimated value of the home; and/or presenting, via the one or more processors, a homeowners insurance quote including the determined homeowners insurance premium to the user.

In some embodiments, the method further includes: analyzing, via the one or more processors, the image from the user to determine a width, a length, and/or a thickness of the countertop in the image from the user; building, via the one or more processors, a digital property profile including: (i) the estimated value of the home, and (ii) a countertop image including a depiction of the countertop with the determined width, length, and/or thickness of the countertop overlaid onto the countertop image; and/or presenting, via the one or more processors, the digital property profile to the user.

In some embodiments, the method further includes analyzing, via the one or more processors, the image from the user to determine a width, a length, and/or a thickness of the countertop in the image from the user; and/or wherein the estimating the value of the home further comprises routing, via the one or more processors, the determined width, length, and/or thickness into the trained home valuation machine learning algorithm.

In another aspect, a computer system configured for determining a countertop type may be provided. The computer system may include one or more local or remote processors, sensors, transceivers, servers, memory units, augmented reality glasses or headsets, extended or virtual reality headsets, smart glasses or watches, wearables, and/or other electronic or electrical components. In one instance, the computer system may include one or more processors configured to: (1) train a countertop identification machine learning algorithm by, during a first training phase: (a) receiving a first plurality of images; (b) identifying bounding boxes in images of the first plurality of images, wherein the bounding boxes surround countertop depictions in the images; (c) identifying labels for countertop types for the countertop depictions surrounded by the bounding boxes, wherein the countertop type labels include: granite, laminate, quartz, wood, ceramic tile, non-laminate, marble, stainless steel, concrete, and/or unknown; and/or (d) training the countertop identification machine learning algorithm based upon the labels for the countertop types; (2) during a second training phase, further train the countertop identification machine learning algorithm by: (a) receiving a second plurality of images, wherein the second plurality of images: (i) includes a greater number of images than the first plurality of images, and/or (ii) includes labeled objects; and/or (b) further training the countertop identification machine learning algorithm based upon the labeled objects; (3) receive an image from a user; and/or (4) route the image from the user into the trained countertop identification machine learning algorithm to identify a type of a countertop in the image from the user. The computer system may include additional, less, or alternate functionality, including that discussed elsewhere herein.

In some embodiments, the first training phase is a supervised learning phase, and/or the one or more processors are configured to identify the bounding boxes according to bounding box input received from trainer devices.

In some embodiments, the one or more processors are configured to identify the labels according to input received from trainer devices.

In some embodiments, the one or more processors are further configured to, during the first training phase: prior to the identifying of the bounding boxes, determine a subset of the first plurality of images that are of a bathroom and/or kitchen; and/or identify the bounding boxes only in the subset of the first plurality of images.

In some embodiments, the one or more processors are further configured to estimate a value of a home by routing the identified type of countertop into a trained home valuation machine learning algorithm.

In some embodiments, the one or more processors are further configured to: determine a homeowners insurance premium based upon the estimated value of the home; and/or present a homeowners insurance quote including the determined homeowners insurance premium to the user.

In some embodiments, the one or more processors are further configured to: analyze the image from the user to determine a width, a length, and/or a thickness of the countertop in the image from the user; build a digital property profile including: (i) the estimated value of the home, and (ii) a countertop image including a depiction of the countertop with the determined width, length, and/or thickness of the countertop overlaid onto the countertop image; and/or present the digital property profile to the user.

In some embodiments, the one or more processors are further configured to: analyze the image from the user to determine a width, a length, and/or a thickness of the countertop in the image from the user; and/or estimate the value of the home further by routing the determined width, length, and/or thickness into the trained home valuation machine learning algorithm.

In yet another aspect, a computer device for determining a countertop type may be provided. The computer device may include (or be configured to work with, such as wirelessly communicate with) one or more local or remote processors, sensors, transceivers, servers, memory units, augmented reality glasses or headsets, extended or virtual reality headsets, smart glasses or watches, wearables, and/or other electronic or electrical components. In one instance, the computer device may include: one or more processors; and/or one or more memories coupled to the one or more processors. The one or more memories including computer executable instructions stored therein that, when executed by the one or more processors, may cause the one or more processors to: (1) train a countertop identification machine learning algorithm by, during a first training phase: (a) receiving a first plurality of images; (b) identifying bounding boxes in images of the first plurality of images, wherein the bounding boxes surround countertop depictions in the images; (c) identifying labels for countertop types for the countertop depictions surrounded by the bounding boxes, wherein the countertop type labels include: granite, laminate, quartz, wood, ceramic tile, non-laminate, marble, stainless steel, concrete, and/or unknown; and/or (d) training the countertop identification machine learning algorithm based upon the labels for the countertop types; (2) during a second training phase, further train the countertop identification machine learning algorithm by: (a) receiving a second plurality of images, wherein the second plurality of images: (i) includes a greater number of images than the first plurality of images, and/or (ii) includes labeled objects; and/or (b) further training the countertop identification machine learning algorithm based upon the labeled objects; (3) receive an image from a user; and/or (4) route the image from the user into the trained countertop identification machine learning algorithm to identify a type of a countertop in the image from the user. The computer device may include additional, less, or alternate functionality, including that discussed elsewhere herein.

In some embodiments, the first training phase is a supervised learning phase, and/or the one or more memories having stored thereon computer executable instructions that, when executed by the one or more processors, further cause the computer device to identify the bounding boxes according to bounding box input received from trainer devices.

In some embodiments, the one or more memories having stored thereon computer executable instructions that, when executed by the one or more processors, further cause the computer device to identify the labels according to input received from trainer devices.

In some embodiments, the one or more memories having stored thereon computer executable instructions that, when executed by the one or more processors, further cause the computer device to, during the first training phase: prior to the identifying of the bounding boxes, determine a subset of the first plurality of images that are of a bathroom and/or kitchen; and/or identify the bounding boxes only in the subset of the first plurality of images.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for determining a type of countertop depicted in an image, comprising:
(a) training, by one or more processors, a countertop identification machine learning algorithm during a first training phase by:
(i) receiving a first plurality of images that include depictions of countertops, wherein each image comprises at least a depiction of a kitchen or bathroom;
(ii) identifying bounding boxes in images of the first plurality of images, wherein each bounding box surrounds a depiction of a countertop;
(iii) associating each bounding box with a countertop type label selected from a group including: granite, laminate, quartz, wood, ceramic tile, non-laminate, marble, stainless steel, concrete, and/or unknown; and
(iv) updating model parameters of the countertop identification machine learning algorithm by supervised learning using the bounding boxes and countertop type labels;
(b) further training, by the one or more processors, the countertop identification machine learning algorithm during a second training phase by:
(i) receiving a second plurality of images, wherein the second plurality of images comprises a greater number of images than the first plurality of images and excludes depictions of countertops but includes labeled depictions of other objects; and
(ii) updating the model parameters of the countertop identification machine learning algorithm by supervised learning to distinguish between countertop and non-countertop objects based upon the labeled depictions of other objects;
(c) receiving, by the one or more processors, a target image from a user;
(d) applying, by the one or more processors, the trained countertop identification machine learning algorithm to the target image to:
(i) identify, within the target image, at least one bounding box corresponding to a depiction of a countertop; and
(ii) determine a countertop type associated with the bounding box, wherein the countertop type is selected from a group including: granite, laminate, quartz, wood, ceramic tile, non-laminate, marble, stainless steel, concrete, and/or unknown; and
(e) presenting, by the one or more processors, an output indicating the determined countertop type for use in evaluating a characteristic of an environment of the target image.

2. The computer-implemented method of claim 1, further including, during the first training phase, identifying, by the one or more processors, the bounding boxes according to bounding box input received from trainer devices.

3. The computer-implemented method of claim 1, wherein the associating each bounding box with a countertop type label includes identifying, by the one or more processors, the labels according to input received from trainer devices.

4. The computer-implemented method of claim 1, further including estimating a value of a home by routing the identified type of countertop into a trained home valuation machine learning algorithm.

5. The computer-implemented method of claim 4, further including:
determining, by the one or more processors, a homeowners insurance premium based upon the estimated value of the home; and
presenting, by the one or more processors, a homeowners insurance quote including the determined homeowners insurance premium to the user.

6. The computer-implemented method of claim 4, further including:
analyzing, by the one or more processors, the target image to determine a width, a length, and/or a thickness of the countertop in the target image;
building, by the one or more processors, a digital property profile including: (i) the estimated value of the home, and (ii) a countertop image including a depiction of the countertop with the determined width, length, and/or thickness of the countertop overlaid onto the countertop image; and
presenting, by the one or more processors, the digital property profile to the user.

7. The computer-implemented method of claim 4, further including analyzing, by the one or more processors, the target image to determine a width, a length, and/or a thickness of the countertop in the target image;
wherein the estimating the value of the home further comprises routing, by the one or more processors, the determined width, length, and/or thickness into the trained home valuation machine learning algorithm.

8. A computer device for determining a type of countertop depicted in an image, the computer device comprising one or more processors configured to:
(a) train a countertop identification machine learning algorithm during a first training phase by:
(i) receiving a first plurality of images that include depictions of countertops, wherein each image comprises at least a depiction of a kitchen or bathroom;
(ii) identifying bounding boxes in images of the first plurality of images, wherein each bounding box surrounds a depiction of a countertop;
(iii) associating each bounding box with a countertop type label selected from a group including: granite, laminate, quartz, wood, ceramic tile, non-laminate, marble, stainless steel, concrete, and/or unknown; and
(iv) updating model parameters of the countertop identification machine learning algorithm by supervised learning using the bounding boxes and countertop type labels;
(b) further train the countertop identification machine learning algorithm during a second training phase by:
(i) receiving a second plurality of images, wherein the second plurality of images comprises a greater number of images than the first plurality of images and excludes depictions of countertops but includes labeled depictions of other objects; and
(ii) updating the model parameters of the countertop identification machine learning algorithm by supervised learning to distinguish between countertop and non-countertop objects based upon the labeled depictions of other objects;
(c) receive a target image from a user;
(d) apply the trained countertop identification machine learning algorithm to the target image to:
(i) identify, within the target image, at least one bounding box corresponding to a depiction of a countertop; and
(ii) determine a countertop type associated with the bounding box, wherein the countertop type is selected from a group including: granite, laminate, quartz, wood, ceramic tile, non-laminate, marble, stainless steel, concrete, and/or unknown; and
(e) present an output indicating the determined countertop type for use in evaluating a characteristic of an environment of the target image.

9. The computer device of claim 8, wherein the one or more processors are further configured to, during the first training phase, identify the bounding boxes according to bounding box input received from trainer devices.

10. The computer device of claim 8, wherein the one or more processors are further configured to associate each bounding box with a countertop type label by identifying the labels according to input received from trainer devices.

11. The computer device of claim 8, wherein the one or more processors are further configured to estimate a value of a home by routing the identified type of countertop into a trained home valuation machine learning algorithm.

12. The computer device of claim 11, wherein the one or more processors are further configured to:
determine a homeowners insurance premium based upon the estimated value of the home; and
present a homeowners insurance quote including the determined homeowners insurance premium to the user.

13. The computer device of claim 11, wherein the one or more processors are further configured to:
analyze the target image to determine a width, a length, and/or a thickness of the countertop in the target image;
build a digital property profile including: (i) the estimated value of the home, and (ii) a countertop image including a depiction of the countertop with the determined width, length, and/or thickness of the countertop overlaid onto the countertop image; and
present the digital property profile to the user.

14. The computer device of claim 11, wherein the one or more processors are further configured to analyze the target image to determine a width, a length, and/or a thickness of the countertop in the target image;
wherein the estimation of the value of the home further comprises routing the determined width, length, and/or thickness into the trained home valuation machine learning algorithm.

15. A computer system for determining a type of countertop depicted in an image, the computer system comprising:
one or more processors; and
one or more memories;
the one or more memories having stored thereon computer-executable instructions that, when executed by the one or more processors, cause the computer system to:
(a) train a countertop identification machine learning algorithm during a first training phase by:
(i) receiving a first plurality of images that include depictions of countertops, wherein each image comprises at least a depiction of a kitchen or bathroom;
(ii) identifying bounding boxes in images of the first plurality of images, wherein each bounding box surrounds a depiction of a countertop;
(iii) associating each bounding box with a countertop type label selected from a group including: granite, laminate, quartz, wood, ceramic tile, non-laminate, marble, stainless steel, concrete, and/or unknown; and
(iv) updating model parameters of the countertop identification machine learning algorithm by supervised learning using the bounding boxes and countertop type labels;
(b) further train the countertop identification machine learning algorithm during a second training phase by:
(i) receiving a second plurality of images, wherein the second plurality of images comprises a greater number of images than the first plurality of images and excludes depictions of countertops but includes labeled depictions of other objects; and
(ii) updating the model parameters of the countertop identification machine learning algorithm by supervised learning to distinguish between countertop and non-countertop objects based upon the labeled depictions of other objects;
(c) receive a target image from a user;
(d) apply the trained countertop identification machine learning algorithm to the target image to:
(i) identify, within the target image, at least one bounding box corresponding to a depiction of a countertop; and
(ii) determine a countertop type associated with the bounding box, wherein the countertop type is selected from a group including: granite, laminate, quartz, wood, ceramic tile, non-laminate, marble, stainless steel, concrete, and/or unknown; and
(e) present an output indicating the determined countertop type for use in evaluating a characteristic of an environment of the target image.

16. The computer system of claim 15, the one or more memories having stored thereon computer executable instructions that, when executed by the one or more processors, further cause the computer system to, during the first training phase, identify the bounding boxes according to bounding box input received from trainer devices.

17. The computer system of claim 15, the one or more memories having stored thereon computer executable instructions that, when executed by the one or more processors, further cause the computer system to associate each bounding box with a countertop type label by identifying the labels according to input received from trainer devices.

18. The computer system of claim 15, the one or more memories having stored thereon computer executable instructions that, when executed by the one or more processors, further cause the computer system to estimate a value of a home by routing the identified type of countertop into a trained home valuation machine learning algorithm.

19. The computer system of claim 18, the one or more memories having stored thereon computer executable instructions that, when executed by the one or more processors, further cause the computer system to:
determine a homeowners insurance premium based upon the estimated value of the home; and
present a homeowners insurance quote including the determined homeowners insurance premium to the user.

20. The computer system of claim 18, the one or more memories having stored thereon computer executable instructions that, when executed by the one or more processors, further cause the computer system to:
analyze the target image to determine a width, a length, and/or a thickness of the countertop in the target image;
build a digital property profile including: (i) the estimated value of the home, and (ii) a countertop image including a depiction of the countertop with the determined width, length, and/or thickness of the countertop overlaid onto the countertop image; and
present the digital property profile to the user.
